(19) United States
(12) Patent Application Publication
(10) Pub. No.: US 2006/0158306 A1
(43) Pub. Date: Jul. 20, 2006

(54) Low resistance SMT resistor

(76) Inventor: Chin-Chi Yang, Taichung Hsien (TW)

Correspondence Address: COOPER & DUNHAM, LLP, 1185 AVENUE OF THE AMERICAS, NEW YORK, NY, 10036, US

(21) Appl. No.: 11/037,969

(22) Filed: Jan. 18, 2005

(51) Int. Cl. H01C 1/012

(52) U.S. Cl. 338/309

(57) ABSTRACT

A low resistance SMT resistor has a substrate, two terminals, at least one strip and a cover. The two terminals are mounted respectively on the two ends of the substrate, and the strip is connected to the two terminals. The cover is mounted on the terminals to cover the strip. The resistance of the resistor is determined by the strip. The material, length and diameter of the strip is easily controlled so the accuracy of the resistance of the resistor is good, especially for resistors with a resistance of less than 1-ohm.

### BACKGROUND OF THE INVENTION

1. Field of the Invention

The present invention relates to a low resistance SMT resistor, and more particularly to a low resistance SMT resistor that is fabricated easily.

2. Description of Related Art

With reference to FIG. 7, a conventional resistor (50) has a base (51), two terminals (54), two conductors (53) and a board (52). The base (51) has an upper face (not numbered), two ends (not numbered), two sides (numbered) and a lower face (not numbered). The two conductors (53) are formed on the upper face respectively close to the two ends. The two terminals (54) are formed at opposite ends of the base (51) on the end, the lower surface and the corresponding conductor (53) so the two terminals (54) are electrically connected to the board (52) through the two conductors (53). The board (52) is formed on the upper face and overlaps the two conductors (53).

The resistance of the conventional resistor is determined by the size and material of the board (52). The common techniques of fabricating the board include printing and coating methods. Neither the printing method nor the coating method is used to fabricate low resistance resistors since small sized boards are hard to fabricate. In general, the resistance of the conventional resistor is larger than 1 ohm. When the two methods are used to fabricate resistors having less than 1-ohm resistance, the accuracy of the resistance of the resistor is not good.

Therefore, the present invention provides a low-resistance SMT resistor that is fabricated easily and has very accurate resistance.

### SUMMARY OF THE INVENTION

The main objective of the present invention is to provide a SMT resistor that is easily fabricated to have less than 1-ohm resistance and very accurate resistance.

The SMT resistor mainly has a substrate, two terminals, at least one strip and a cover. The two terminals are mounted respectively on the two ends of the substrate, and the strip is mounted on the two terminals. The cover is mounted on the substrate to cover the strip. The resistance of the resistor is mainly determined by the strip. The material, length and diameter of the strip is easily controlled so the accuracy of the resistance of the resistor is good, especially a resistor with less than 1-ohm resistance. Further, the strip is mounted on the two terminals with wire-bonding techniques so fabricating the present invention is easy.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a low resistance SMT resistor in accordance with the present invention;

FIG. 2 is a partially exploded perspective view of the resistor in FIG. 1;

FIG. 3 is a cross sectional side view of the resistor in FIG. 1;

FIG. 4 is a perspective view of a second embodiment of a low resistance SMT resistor in accordance with the present invention;

FIG. 5 is a partially exploded perspective view of the resistor in FIG. 4;

FIG. 6 is a circuit diagram with the low resistance SMT resistor in accordance with the present invention; and

FIG. 7 is a perspective view of a conventional resistor in accordance with the prior art.

### DETAILED DESCRIPTION OF THE PREFERRED EMBODIMENT

With reference to FIGS. 2 and 5, an SMT resistor (10) in accordance with the present invention includes a substrate (11), two terminals (12), at least one strip (13) and a cover (14).

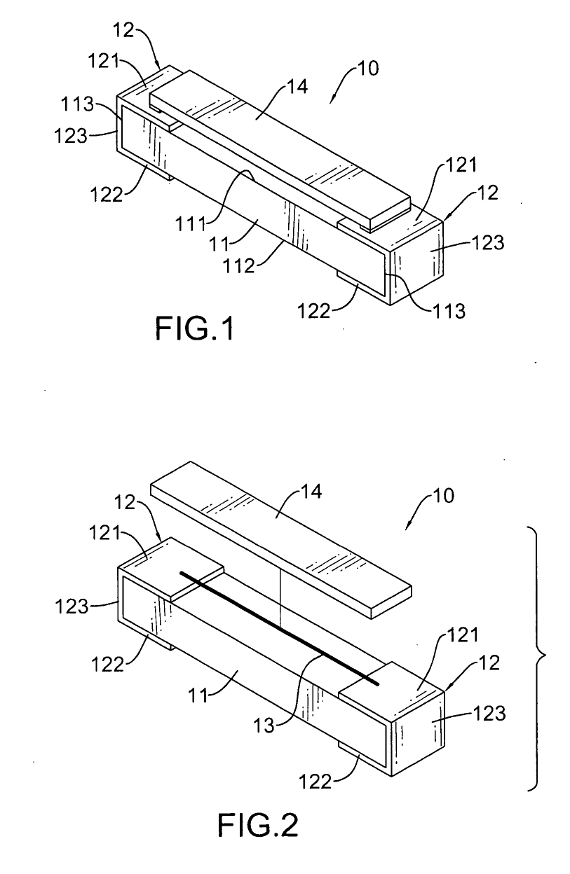

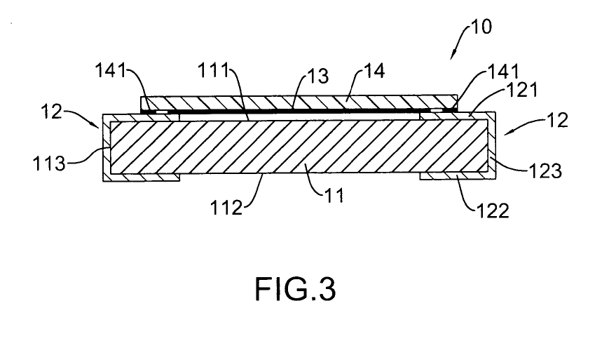

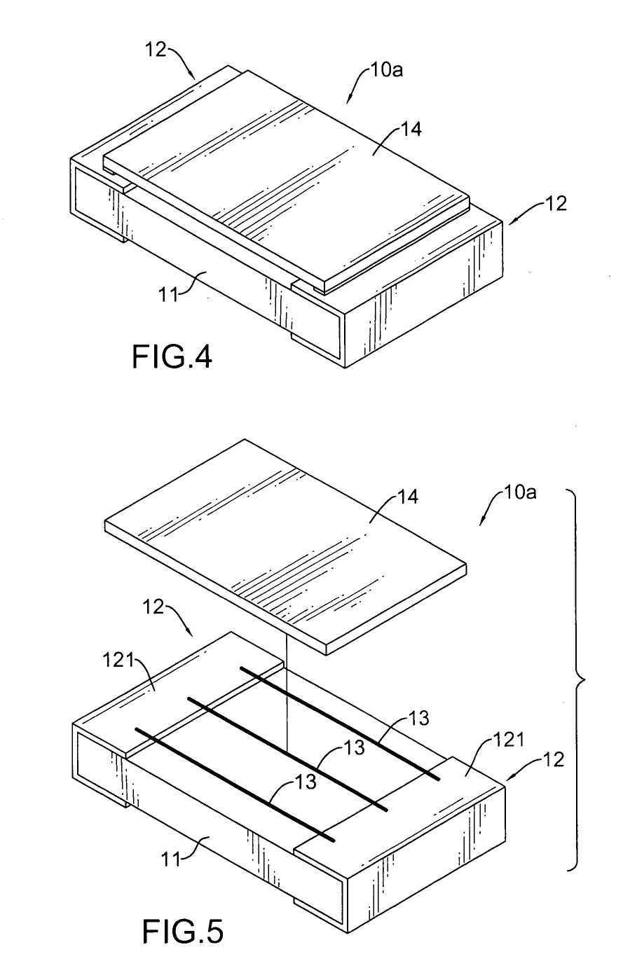

With further reference to FIGS. 1 and 3, the substrate (11) has an upper face (111), a lower face (112), two ends (113) and two sides. The substrate (11) can be made of fiberglass (FR4) or ceramic material.

Each terminal (12) is U-shaped and has an upper longitudinal arm (121), a cross member (123) and a lower longitudinal arm (122). The upper and lower longitudinal arms (121, 122) and the cross member (123) are formed as a single piece. The upper and lower longitudinal arms (121, 122) are mounted respectively on the upper and lower faces (111, 112) adjacent to the ends (113). The cross members (123) are mounted respectively on the ends (113).

A first embodiment of the SMT resistor (10) in accordance with the present invention has one strip (13) connected between the two upper longitudinal arms (121) of the two terminals (12). The cover (14) is mounted on the upper longitudinal arms (121) of the terminal (12) with an adhesive (141) to cover the strip (13).

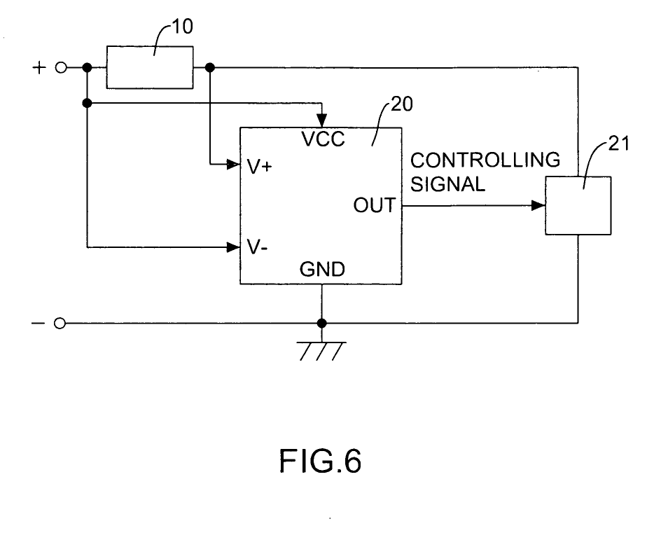

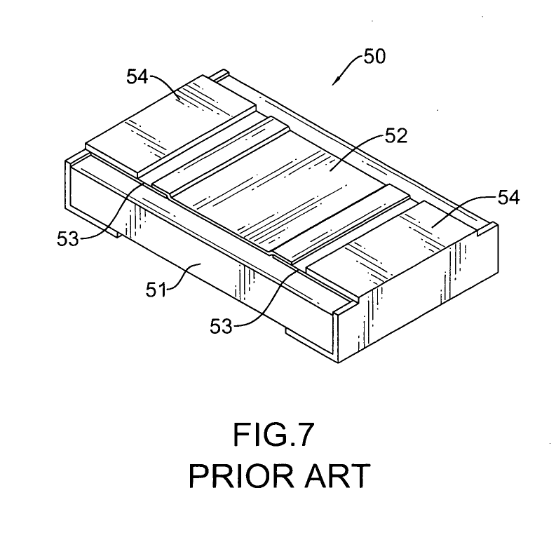

With further reference to FIG. 6, a second embodiment of the SMT resistor (10a) in accordance with the present invention includes a substrate (11), two terminals (12), three strips (13) and a cover (14). The structure of the elements and interfaces among elements only vary in quantity and size from those of the first embodiment. The three strips (13) are connected between the two upper longitudinal arms (121) of the two terminals (12).

To easily fabricate low-resistance SMT resistors (lower than 1-ohm), each strip (13) has a diameter in a range of 0.8 mil to 10 mil. The strip's length, material diameter of determines the resistance of the SMT resistor (10, 10a). The strip (13) is made of high impedance material such as tungsten or nickel. The strip (13) can be easily attached to the two upper longitudinal arms (121) of the two terminals (12) with wire-bonding techniques. Wire-bonding techniques is common technology so fabricating the present invention is easy and not complex. In addition, the strip (13) has a small diameter so the resistance can be low.

The strip (13) is prepared before fabricating the SMT resistor (10) in accordance with the present invention, so the present invention has a much more accurate resistance than conventional resistors made by printing or coating methods.

The structure of the SMT resistor (10, 10a) in accordance with the present invention allows the resistor (10,10a) to be fabricated with different resistances in the following ways.

1. Choosing different diameter strips (13). The formula

$$R = ρ \frac{l}{A} ,$$

where ρ is a constant, A is the cross sectional area of the strip (13), and l is the length of the strip (13), makes determining the resistance R easy.

(A) To fabricate higher resistance resistors of less than 1-ohm, the length of the strips (13) can be shortened, or the diameter of the strips (13) can be decreased.

(B) To fabricate lower resistance resistors less than 1-ohm, the length of the strips (13) can be increased, or the diameter of the strips (13) can be increased.

2. Choosing numbers of strips (13). Any number of strips (13) can be mounted between the two terminals (12). Multiple strips (13) connected between the two terminals (12) will result in a lower resistance than the resistance of a single strip (13) of the same size. Therefore, low-resistance resistors can be fabricated with different resistance by choosing different numbers of strips (13) between the two terminals (12).

With reference to FIG. 6, the SMT resistor (10) in accordance with the present invention is used in a controlling circuit having a current protection capability. The controlling circuit has a controller (20) and a current sensor implemented with an SMT resistor (10). Specifically, the SMT resistor (10) is connected between the power input of a load (21) and a terminal (+) of the power source. When the power source (+, −) provides power to the controller (20), current passes through the SMT resistor (10), and a voltage drop is generated across the SMT resistor (10). Two inputs (V+, V−) of the controller (20) are connected two ends of the SMT resistor (10) to obtain the voltage drop across the SMT resistor (10). If the current is abnormal, the voltage drop across the SMT resistor (10) will change, and the controller (20) will adjust the abnormal current or send a control signal to disconnect the load (21).

Based on the forgoing description, the present invention has a resistance of less than 1-ohm that is very accurate. Further, the resistor can be fabricated easily by wire-bonding techniques. Therefore, the fabricating steps are simpler than the printing or coating methods.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A low resistance SMT resistor, comprising
a substrate having an upper face, a lower face, two ends and two sides;
two terminals mounted respectively on the two ends;
at least one strip having a diameter in a range of 0.8 mil to 10 mil and connected between the two terminals; and
a cover mounted on the terminals on the upper face of the substrate to cover the strip.

2. The low resistance SMT resistor as claimed in claim 1, wherein each terminal has
an upper longitudinal arm mounted on the upper face of the substrate adjacent to a corresponding end;
a lower longitudinal arm mounted on the lower face of the substrate adjacent to the corresponding end; and
a cross member formed with the upper and lower longitudinal arms.

3. The low resistance SMT resistor as claimed in claim 1, wherein the upper and lower longitudinal arms and the cross member are formed as a single piece.

4. The low resistance SMT resistor as claimed in claim 1, wherein the substrate is made of fiberglass (FR4).

5. The low resistance SMT resistor as claimed in claim 1, wherein the substrate is made of ceramic material.

6. The low resistance SMT resistor as claimed in claim 1, wherein the strip is made of high impedance material.

7. The low resistance SMT resistor as claimed in claim 6, wherein the high impedance material is tungsten.

8. The low resistance SMT resistor as claimed in claim 6, wherein the high impedance material is nickel.
